(19) United States
(12) Patent Application Publication
(10) Pub. No.: US 2010/0036042 A1
(43) Pub. Date: Feb. 11, 2010

(54) METHOD OF VISCOSITY LOWERING OF AQUEOUS DISPERSIONS OF A WATER-SOLUBLE ADDITION POLYMERS

(75) Inventors: Christian Krueger, Speyer (DE); Audrey Renoncourt, Ludwigshafen (DE); Henning Boelter, Wattenheim (DE); Ralf Mossbach, Lindenberg (DE); Klaus Haas, Ludwigshafen (DE); Manfred Weber, Mannheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/518,282

(22) PCT Filed: Dec. 10, 2007
(86) PCT No.: PCT/EP2007/063579

§ 371 Date: Jun. 9, 2009

(30) Foreign Application Priority Data
Dec. 11, 2006 (EP) 06125825.7

(51) Int. Cl. C08L 51/00; C08L 33/02; C08L 33/08; C08L 37/00

(52) U.S. Cl. 524/504; 524/502; 524/522; 524/523; 524/517

(57) ABSTRACT

The present invention provides a method of viscosity lowering of an aqueous dispersion of a water-soluble addition polymer.

The present invention provides a method of viscosity lowering of an aqueous dispersion of a water-soluble addition polymer, which comprises adding to said aqueous dispersion of said water-soluble addition polymer at least
a) one addition homopolymer of acrylic acid having a weight-average molecular weight Mw≦20 000 g/mol [polymer A] and/or
b) one addition copolymer of acrylic acid and maleic anhydride having a weight-average molecular weight Mw≦20 000 g/mol [polymer B]
   in an amount of 0.1% to 20% by weight, based on the aqueous polymer dispersion.

Aqueous addition polymer solutions are frequently prepared by free-radically polymerizing corresponding ethylenically unsaturated monomers in aqueous medium. A problem with these aqueous polymer solutions, however, is that even at low levels of addition polymer solids they have high viscosities. In the course of the further processing of the aqueous polymer solutions, therefore, they would have either an undesirably low polymer solids content or an undesirably high viscosity. Through addition of specific organic or inorganic compounds, particularly salts, before, during or after the polymerization, the solubility of the dissolved polymers in the aqueous medium is reduced to an extent such that the water-soluble polymers are present in the form of a heterogeneous phase in the aqueous medium (i.e., aqueous dispersions of water-soluble polymers). Where these organic or inorganic compounds are added to the aqueous medium before and/or during the polymerization, it is possible to prepare aqueous dispersions of water-soluble polymers which, with the same or a lower viscosity, have much higher polymer solids contents than the corresponding aqueous polymer solutions.

Aqueous dispersions of water-soluble addition polymers and their preparation using specific organic or inorganic compounds are known to the skilled worker (see, for example, DE-A 10041394, DE-A 10110831, FR-A 2815635, FR-A 2816833, U.S. Pat. No. 4,380,600, U.S. Pat. No. 4,883,536, U.S. Pat. No. 5,605,970, EP-A 183466, EP-A 984990, WO 97/34933, WO 01/17914, WO 03/46024, WO 05/12378, WO 05/100415 or WO 05/100416).

Nevertheless, aqueous dispersions of water-soluble addition polymers, following their preparation using specific organic or inorganic compounds, frequently still have viscosities which cannot be lowered any further or much further by additional quantities of the organic or inorganic compounds used for their preparation.

The object was to provide compounds which allow further lowering of the viscosities of aqueous dispersions of water-soluble addition polymers.

Surprisingly this object has been achieved through the method defined at the outset.

Suitable addition polymers A include all homopolymers of acrylic acid having a weight-average molecular weight Mw≦20 000 g/mol. Addition homopolymers of acrylic acid are all oligomeric or polymeric compounds which are synthesized from at least five acrylic acid units and therefore have a molecular weight≧360 g/mol. The polymers A preferably have a weight-average molecular weight≧500 g/mol and ≦15 000 g/mol and with particular preference ≧1000 g/mol and ≦10 000 g/mol or ≧1000 g/mol and ≦5000 g/mol.

The preparation of the polymers A is familiar to the skilled worker and is accomplished for example by free-radical addition polymerization of acrylic acid using free-radical chain regulators in a polar solvent, such as alcohols, for example, such as methanol, ethanol or isopropanol, ketones, such as acetone or methyl ethyl ketone, cyclic ethers, such as tetrahydrofuran, sulfoxides, such as dimethyl sulfoxide, formamides, such as dimethylformamide, and also, in particular, in water (see, for example, Ullmann Encyclopedia, Wiley VCH, 6th Edition, 2000, Electronic Release, “Polyacrylates” section). It will be appreciated that mixtures of polar solvents can also be used.

The polymers A for the purposes of this specification of course also comprise the acrylic acid homopolymers neutralized wholly or partly with typical bases, such as alkali metal or alkaline earth metal hydroxides, ammonium hydroxide, and organic amino compounds.

Suitable polymers B include all addition copolymers of acrylic acid and maleic anhydride having a weight-average molecular weight Mw≦20 000 g/mol. Addition copolymers of acrylic acid and maleic anhydride are all oligomeric or polymeric compounds which are synthesized from at least two acrylic acid units and at least two maleic anhydride units and therefore have a molecular weight≧340 g/mol. The polymers B preferably have a weight-average molecular weight≧500 g/mol and ≦15 000 g/mol and with particular preference ≧1000 g/mol and ≦10 000 g/mol or ≧1000 g/mol and ≦5000 g/mol.

The preparation of the addition polymers B is familiar to the skilled worker and is accomplished for example by free-radical addition polymerization of acrylic acid and maleic anhydride using free-radical chain regulators in a polar solvent, such as, for example, alcohols, such as methanol, ethanol or isopropanol, ketones, such as acetone or methyl ethyl ketone, cyclic ethers, such as tetrahydrofuran, sulfoxides, such as dimethyl sulfoxide, formamides, such as dimethylformamide, and also, in particular, in water (see, for example, DE-A 3138574, DE-A 3147489, B. C. Trivedi, B. M. Culbertson, Maleic Anhydride, Chapter 9, 9.2.5 Acrylic Acid, Plenum Press 1982, New York). It will be appreciated that mixtures of polar solvents can also be used.

The addition polymers B in the context of this specification of course also comprise the maleic acid derivatives formed by reaction of the anhydride groups with water, and also the acrylic acid/maleic acid copolymers partly or wholly neutralized with typical bases, such as alkali metal or alkaline earth metal hydroxides, ammonium hydroxide, and organic amino compounds.

The polymer B is advantageously synthesized from acrylic acid and maleic anhydride in a quantitative ratio of 9:1 to 1:9, preferably 5:1 to 1:5, and with particular preference 3:1 to 1:3.

The weight-average molecular weights of the polymers A and B are determined in a manner familiar to the skilled worker, by a gel permeation chromatography method along the lines of DIN 55672-1 (for example, at 35° C. on Suprema separating columns using as eluent deionized water buffered to a pH of 7).

For the viscosity lowering of an aqueous dispersion of a water-soluble addition polymer, said dispersion is admixed with 0.1% to 20%, frequently 1% to 15%, and often 2% to 10% by weight, based in each case on the aqueous dispersion of the water-soluble polymer, of at least one of the aforementioned polymers A and/or B. The nature and the amount of the polymers A and/or B to be added for viscosity lowering is heavily dependent on the aqueous dispersion of the water-soluble polymer, particularly on the nature and amount of the water-soluble polymer, the nature and amount of the organic or inorganic compounds used to form the heterogeneous phase, and also the extent of required viscosity lowering. If necessary, it is possible for the skilled worker to determine the appropriate nature and amount of the at least one polymer A and B by means of a few routine experiments. It will be appreciated that for viscosity lowering it is possible to use individual polymers, A or B, or else mixtures thereof.

With particular advantage the present method of the invention is suitable for viscosity lowering of an aqueous dispersion of a water-soluble addition polymer which has been prepared by free-radically induced addition polymerization of at least one ethylenically unsaturated monomer MON in the presence of at least one water-soluble polymer X and at least one water-soluble polymer Y, the at least one water-soluble polymer X being selected from
(a1) addition graft polymers of vinyl acetate and/or vinyl propionate on polyalkylene glycol or on polyalkylene glycol substituted at one or both ends by alkyl, carboxyl or amino groups,
(a2) addition copolymers of alkylpolyalkylene glycol (meth)acrylates and (meth)acrylic acid,
(a3) polyalkylene glycols,
(a4) polyalkylene glycols substituted at one or both ends by alkyl, carboxyl or amino groups,
   and the at least one water-soluble polymer Y being selected from
(b1) hydrolyzed addition copolymers of vinyl alkyl ethers and maleic anhydride as free polyacid or at least partially neutralized with alkali metal hydroxides or ammonium bases,
(b2) starch, modified or unmodified,
(b3) synthetic addition copolymers obtainable by copolymerizing
(β1) one or more nonionic monoethylenically unsaturated monomers,
(β2) one or more cationic monoethylenically unsaturated monomers,
(β3) optionally one or more anionic monoethylenically unsaturated monomers,
   the molar fraction of cationic monoethylenically unsaturated monomers (β2) copolymerized in (b3) being higher than the fraction of copolymerized anionic monoethylenically unsaturated monomers (β3).

Addition polymer systems of this kind are disclosed in DE-A 102004063004, more particularly in paragraphs [0038] to [0152], which are hereby incorporated by reference.

The addition of the viscosity-lowering polymers A and/or B to the aqueous dispersions of water-soluble polymers is made in general in the temperature range ≧0° C. and ≦100° C., preferably ≧10° C. and ≦80° C., and with particular preference >20° C. and ≦70° C. at atmospheric pressure (1 atm=1.013 bar absolute) under an inert gas atmosphere or air atmosphere. It will be appreciated that the addition of the polymers A and/or B can also be made at higher pressures. The addition of the polymers A and/or B takes place advantageously with mixing, in particular with stirring, of the aqueous polymer dispersions, the mixing operation being continued until the polymers A and/or B are homogeneously distributed in the aqueous polymer dispersions.

The viscosities achieved by adding the viscosity-lowering polymers A and/or B to the aqueous dispersions of water-soluble polymers are—for a given measurement temperature—lower by generally ≧200 mpas, frequently ≧500 mpas, and often indeed ≧1000 mPas than the viscosities of the unadditized aqueous polymer dispersions to which no additional polymers A and/or B have been admixed. The determination of the viscosities of aqueous polymer dispersions is familiar to the skilled worker and is accomplished in particular by the Brookfield measurement method (DIN EN ISO 2555).

The low-viscosity aqueous dispersions of water-soluble addition polymers that are obtained in accordance with the invention can be employed with particular advantage as a component in the production of adhesives, sealants, polymeric renders, paper coating slips, fiber webs, paints, drugs, cosmetics, and coating materials for organic or inorganic substrates and also for modifying mineral binders or plastics.

The nonlimiting examples which follow are intended to illustrate the invention.

Preparation of an aqueous dispersion of a water-soluble addition polymer

A 2I HWS vessel equipped with an anchor stirrer and with two metering devices was charged at 20 to 25° C. (room temperature) under a nitrogen atmosphere with 401 g of deionized water, 453 g of an aqueous solution of a vinyl acetate/polyethylene glycol graft polymer (vinyl acetate/polyethylene glycol quantitative ratio: 60/40; solids content 18.7% by weight; Sokalan® HP 22G from BASF AG), 214 g of an aqueous solution of a maleic anhydride/vinyl methyl ether copolymer (maleic anhydride/vinyl methyl ether quantitative ratio: 62.8/37.2; solids content: 35.3% by weight; Lupasol® MS from BASF AG). This solution was admixed with stirring with 50 g of acrylic acid and 0.011 g of 2,2′-azobis(2-amidinopropane) dihydrochloride (Wako V 50 from Wako) in solution in 2.33 g of deionized water and the resulting reaction mixture was heated to 64° C. over 20 minutes. After the temperature had been reached, the monomer feed, consisting of 75 g of acrylic acid and 0.63 g of trimethylolpropane ethoxylate triacrylate (Sartomer® SR 9035 from Sartomer) over the course of 3.5 hours, and the initiator feed, composed of 0.09 g of Wako V 50 and 20 g of deionized water, over the course of 4 hours, were metered in continuously, beginning simultaneously. After the end of metering of the initiator feed, the polymerization mixture was allowed to continue stirring at 64° C. for 30 minutes, after which a further 0.16 g of Wako V 50, in solution in 33.5 g of deionized water, was added. The resulting aqueous polymer dispersion was then left to react at 64° C. for 2 hours more. Thereafter the resulting aqueous polymer dispersion was cooled to room temperature and its viscosity was found to be 2250 mPas.

The viscosities of the aqueous polymer dispersions were determined generally in accordance with DIN EN ISO 2555 using a Brookfield RVT viscometer with spindle 3, at 20 revolutions per minute; temperature: 23° C.; polymer concentration (solids content) as indicated in examples.

Determination of viscosities following addition of the addition polymers of the invention

The viscosities were determined generally by homogeneously mixing 125 g of the above-described aqueous polymer dispersion at room temperature with 12.5 g of a 24% strength by weight aqueous solution of a polymer A or of a polymer B (based on polymer solids) and then determining the viscosity of the aqueous polymer dispersion obtained. Polymer A (Example 1) used was a polyacrylic acid having a weight-average molecular weight of 4000 g/mol [Sokalan® CP 10 from BASF AG] and polymer B (Example 2) was a copolymer of acrylic acid and maleic anhydride in a weight ratio of 42.3/57.7 with a weight-average molecular weight of 3000 g/mol [Sokalane CP 12S from BASF AG]. The results obtained are listed in Table 1. The base viscosity was determined by homogeneously mixing 125 g of the above-described aqueous polymer dispersion with 12.5 g of deionized water (base value).

For purpose of comparison, 453 g of an aqueous solution of a vinyl acetate/polyethylene glycol graft polymer (vinyl acetate/polyethylene glycol quantitative ratio: 60/40; solids content: 18.7% by weight, Sokalan® HP 22G) and 214 g of an aqueous solution of a maleic anhydride/vinyl methyl ether copolymer (maleic anhydride/vinyl methyl ether quantitative ratio: 62.8/37.2; solids content: 35.3% by weight, Lupasol® MS) were mixed homogeneously in a stirring flask. The solids content of the polymer solution obtained was calculated at 24% by weight. Again, 12.5 g of the resulting polymer solution were used. The result obtained is likewise listed in Table 1 (comparative example).

TABLE 1
Viscosities

| Example | Viscosity [mPas] |
|---|---|
| Base value | 2320 |
| 1 | 530 |
| 2 | 650 |
| Comparative | 1980 |

1. A method of lowering viscosity of an aqueous dispersion of a water-soluble addition polymer, comprising adding to said aqueous dispersion of said water-soluble addition polymer at least one of
a) polymer A of homopolymer of acrylic acid having a weight-average molecular weight Mw≦20 000 g/mol and
b) polymer B of copolymer of acrylic acid and maleic anhydride having a weight-average molecular weight Mw≦20 000 g/mol
in an amount of 0.1% to 20% by weight, based on the aqueous polymer dispersion.

2. The method according to claim 1, wherein a weight-average molecular weight, Mw, of said polymer A is in a range of 1000 ≦Mw≦10000g/mol.

3. The method according to claim 1, wherein a weight-average molecular weight, Mw, of said polymer B is in a range of 1000 ≦Mw≦10000 g/mol.

4. The method according to claim 1, comprising synthesizing polymer B from acrylic acid and maleic anhydride in a quantitative ratio of 9:1 to 1:9.

5. The method according to claim 1, comprising carrying out free-radically induced addition polymerization of at least one ethylenically unsaturated monomer MON in the presence of at least one water-soluble polymer X and at least one water-soluble polymer Y, to obtain the aqueous dispersion of a water-soluble addition polymer wherein the at least one water-soluble polymer X is
(a1) an addition graft polymer of vinyl acetate and/or vinyl propionate on polyalkylene glycol or on polyalkylene glycol substituted at one or both ends by alkyl, carboxyl or amino groups,
(a2) an addition copolymer of alkylpolyalkylene glycol (meth)acrylates and (meth)acrylic acid,
(a3) a polyalkylene glycol, or
(a4) a polyalkylene glycol substituted at one or both ends by alkyl, carboxyl or amino groups,
and the at least one water-soluble polymer Y is
(b1) a hydrolyzed addition copolymer of vinyl alkyl ethers and maleic anhydride as free polyacid or at least partially neutralized with alkali metal hydroxides or ammonium bases,
(b2) a starch, modified or unmodified, or
(b3) a synthetic addition copolymer obtained by copolymerizing at least one of
(β1) one or more nonionic monoethylenically unsaturated monomers,
(β2) one or more cationic monoethylenically unsaturated monomers, and
(β3) optionally one or more anionic monoethylenically unsaturated monomers,
wherein the molar fraction of cationic monoethylenically unsaturated monomers (β2) copolymerized in (b3) is higher than the fraction of copolymerized anionic monoethylenically unsaturated monomers (β3).

6. A lowered-viscosity aqueous dispersion of a water-soluble addition polymer obtained by a method according to claim 1.

7. An adhesive, a sealant, a polymeric render, a paper coating slip, a fiber web, a paint, a drug, or a cosmetic or coating material for organic or inorganic substrates or for modifying mineral binders or plastics, comprising an aqueous dispersion of a water-soluble addition polymer according to claim 6.
